(19) United States
(12) Patent Application Publication
(10) Pub. No.: US 2010/0312487 A1
(43) Pub. Date: Dec. 9, 2010

(54) MASS ANALYSIS DATA ANALYZING METHOD AND APPARATUS THEREOF

(75) Inventor: Shinichi Yamaguchi, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: Shimadzu Corporation, Nakagyo-ku (JP)

(21) Appl. No.: 12/445,882

(22) PCT Filed: Nov. 15, 2006
(86) PCT No.: PCT/JP2006/322741

§ 371 Date: Apr. 16, 2009

(51) Int. Cl. G06F 19/00

(52) U.S. Cl. 702/23

(57) ABSTRACT

In deducing the composition of an unknown metabolite, information on the kind of reaction and the component which is added or dropped is provided, based on the prediction and knowledge on the pathways of metabolism (S5). Then, based on the information, the kind of elements and the maximum value of the increase and decrease in the number of atoms of the elements are computed. In addition, based on the values and the composition of the original substance, the kind of the unknown substance and the possible range of numbers of atoms thereof are obtained (S6 and S7). Using the element's kind and range of numbers as a computational condition, the combination of elements that matches the mass of the unknown metabolite obtained by a mass analysis is searched to deduce the composition of the unknown metabolite (S8). Since the computational condition is fairly limited, the composition can be deduced with a practical amount of computation and with a high degree of accuracy.

### TECHNICAL FIELD

The present invention relates to a data analyzing method and an apparatus thereof, for identifying a substance generated by a chemical change of a metabolite or other substances by using the data obtained by a mass analysis.

### BACKGROUND ART

In the fields of diagnosing a variety of diseases and illnesses, assessment of the effectiveness and safety of drugs and functional foods, and research on lifestyle and health, it is crucial to analyze a metabolite which is the product of a chemical change in a living organism. In recent years, a method called Metabolomics for exhaustively analyzing a metabolite has been attracting attention.

One useful method to perform such an analysis of a metabolite is to combine a chromatography (typically, a high-performance liquid chromatography) and a high-accuracy mass spectrometer (refer to Non-Patent Document 1 or other documents). In this case, a metabolite is required to be searched by analyzing a mass spectrum obtained by the mass spectrometer. Generally, in a conventional search of a metabolite, a database is previously created in which the masses (specifically, the mass-to-charge ratio) of metabolites whose composition and structure are known are registered, and a metabolite is identified by comparing the mass of the peak appearing on the mass spectrum obtained by an analysis and the database.

However, such a conventional search method has the following disadvantages: if an unknown metabolite which is not registered in the database exists in a sample, the metabolite cannot be found. Even if it is possible to deduce that a peak corresponds to the unknown metabolite, the metabolite's composition cannot be known.

The aforementioned problems occur not only in searching for a metabolite, but also in searching for a product generated as a result of some sort of chemical change of a certain substance whose composition is known.

[Non-Patent Document 1] “Shimadzu's metabolomics solution”, Shimadzu Corporation, Internet <URL: http://www.an.shimadzu.co.jp/topics/2006/200610/metabo/metabolome.htm> [Nov. 8, 2006]

### DISCLOSURE OF THE INVENTION

### Problems to be Solved by the Invention

The present invention has been devised to solve the aforementioned problems, and the objective thereof is to provide a mass analysis data analyzing method and an apparatus thereof, capable of, even in the case where a product is unknown which is generated by a chemical change of an original substance whose composition is known, accurately deducing the composition of the product based on the mass spectrum data obtained by a mass analysis.

### Means for Solving the Problems

The first aspect of the present invention developed to solve the aforementioned problems provides a mass analysis data analyzing method for deducing the composition of a product generated by a chemical change of an original substance whose composition is known, based on data obtained by mass analyzing the product, including:

a) an information provision step for providing prediction information on the chemical change;

b) a condition computation step for computing, based on the prediction information, a maximum increase and a maximum decrease in the number of atoms of each element from the original substance by the chemical change and/or a maximum value and a minimum value of the number of atoms of each element constituting the product; and

c) a composition deduction step for deducing the composition of the product to match the mass of the product obtained by a mass analysis, under a computational condition of the maximum increase and the maximum decrease in the number of atoms of each element or the maximum value and the minimum value of the number of atoms of a constituent element of the product computed in the condition computation step.

The second aspect of the present invention, for realizing the mass analysis data analyzing method according to the first aspect of the invention, provides a mass analysis data analyzing apparatus for deducing the composition of a product generated by a chemical change of an original substance whose composition is known, based on data obtained by mass analyzing the product, including:

a) an information provision section for providing prediction information on the chemical change;

b) a condition computation section for computing, based on the prediction information, a maximum increase and a maximum decrease in the number of atoms of each element from the original substance by the chemical change and/or a maximum value and a minimum value of the number of atoms of each element constituting the product; and

c) a composition deduction section for deducing the composition of the product to match the mass of the product obtained by a mass analysis, under a computational condition of the maximum increase and the maximum decrease in the number of atoms of each element or the maximum value and the minimum value of the number of atoms of a constituent element of the product computed by the condition computation section.

The aforementioned “chemical change” is typically a metabolism and in this case the “product” is a metabolite (or metabolic product). Many metabolic pathways are known from a variety of past studies. For example, it is known that a drug metabolism which is important for verifying the effectiveness and safety of drugs can be roughly divided into two stages of the first phase reaction and the second phase reaction. In the first phase reaction, a polar group such as a hydroxyl group, carboxyl group, or amino group is often generated or introduced into an original substance by an oxidation, reduction, hydrolysis, or other reactions.

Given this factor, in the apparatus which realizes the mass analysis data method according to the present invention, a user provides, based on the deduction and knowledge of such a metabolic pathway and other factors, the information on a portion (e.g. polar group) which might be added to the original substance, dropped from the original substance, or substituted in the original substance by a metabolic reaction for example through the information provision section. This operation can be performed, for example, by allowing the user to select one or more options from among many previously prepared options.

After the prediction information is provided as just described, based on the prediction information, the condition computation section respectively computes the maximum value of the increase and the maximum value of the decrease in the number of atoms of each element from the original substance by a metabolism. For example, in a reaction in which a hydroxyl group (—OH) is added, one oxygen atom and one hydrogen atom are respectively added. If some possibilities of reactions are specified, according to this specification, the range of the increase or decrease of the number of atoms of each element from the original substance, i.e. the maximum increase and the maximum decrease, is determined. Since the original substance's composition, i.e. the number of atoms of each constituent element, is known, the maximum value and minimum value of the number of atoms of each constituent element of the product can be obtained by using the maximum increase and maximum decrease.

Given the mass of the product to be identified, the composition deduction section searches for the combination of the kind and number of atoms of the elements to match the product's mass, under the computational condition of, for example, the maximum value and minimum value of the number of atoms of each constituent element of the aforementioned product, i.e. the possible range of the number of atoms of the elements. Since a mass analysis might have a certain level of error, an appropriate tolerable range may be set to the mass, and an element included in the range may be selected as a candidate for the composition. If the kind of element and the range of the number of atoms thereof are not set, the search for the composition using the consistency with the mass as previously described is practically impossible since the combination number is too large. However, since the kind and number of atoms of the elements are reasonably limited in the present invention, a search can be carried out in a relatively short period of time, and one or more candidates for the composition can be accurately found.

In the case where it is previously known or can be accurately deduced that the chemical change concerned is a simple change that only adds one or more certain elements to an original substance or inversely drops one or more certain elements from the original substance, the product's composition may often be advantageously deduced by using the difference between the mass of the original substance and the mass of the product. This is because in many cases such a mass difference has a smaller value than the value of the original mass, and the number of combinations of the elements to be searched is small.

In this case, given the mass of the product to be identified, the composition deduction section computes the difference between the given mass of the product and the mass of the original substance, and searches for the combination of the kind and number of atoms of the elements to match the mass difference under the condition of the maximum increase and maximum decrease in the number of atoms of each constituent element associated with a chemical reaction. The element deduced in this manner is considered to have been added to or dropped from the original substance, and the composition of the product is deduced. With this method, the amount of computation associated with the compositional deduction can be reduced.

### EFFECTS OF THE INVENTION

With the mass analysis data analyzing method and the apparatus thereof according to the present invention, even in the case where the product produced by a chemical change such as a metabolism for example is unknown, the composition can be deduced with a high degree of accuracy.

As a matter of course, in deducing the product's composition, the candidates can be refined by using other information on deduction, in addition to performing a search based on the consistency between the mass or mass difference and the combination of the kind and number of atoms of the constituent elements as previously described.

For example, in the case where an MSⁿ analysis (where n is equal to or more than two) can be performed, an MS² analysis can be performed in which an unknown product is set as a precursor ion to obtain a mass spectrum on which a plurality of fragment peaks originating from the product appear. Based on the mass spectrum, the mass of each fragment ion can be obtained, and based on the mass, the composition of the original product can be deduced. Accordingly, using this deduction result, the candidates for the product can be narrowed down.

In the case where a plurality of candidates for the composition are gathered, the consistency between the isotopic distribution computed from each composition formula and the actually observed isotopic distribution may be examined, and based on the consistency, the candidates for the composition may be refined and the ranking of the reliabilities may be placed.

### BRIEF DESCRIPTION OF THE DRAWINGS

FIG. 1 is a schematic configuration diagram of an embodiment of the mass analyzing system including the data analyzing apparatus according to the present invention.

FIG. 2 is a flowchart illustrating an example of the procedure of the analysis processing operation of an unknown metabolite by the mass analyzing system of the present embodiment.

### EXPLANATION OF NUMERALS

1 . . . Mass Spectrometer
2 . . . Data Processor
21 . . . Mass Spectrum Creator
22 . . . Metabolite Identification Processor
23 . . . Deduction Condition Setting Section
3 . . . Input Unit
4 . . . Output Unit

### BEST MODE FOR CARRYING OUT THE INVENTION

Hereinafter, an embodiment of the data analyzing apparatus according to the present invention will be specifically explained with reference to the figures.

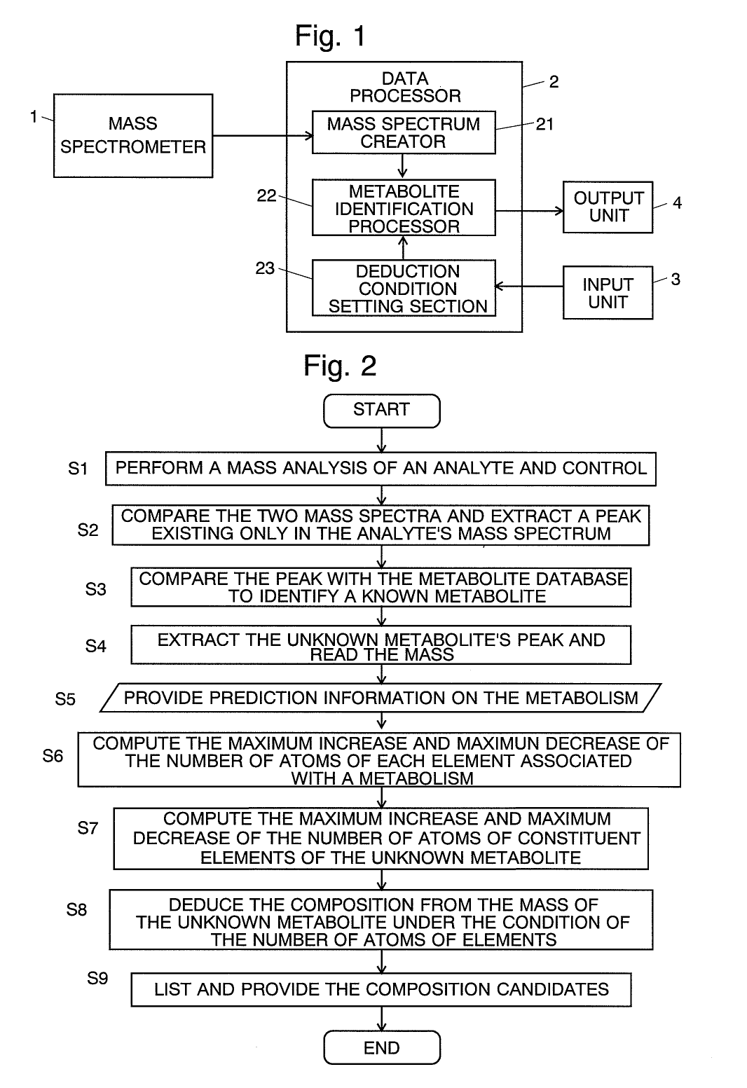

FIG. 1 is a schematic configuration diagram of an embodiment of the mass analyzing system including the data analyzing apparatus according to the present invention. The mass spectrometer 1 is, for example, an ion trap time-of-flight mass spectrometer (IT-TOFMS), and performs a mass analysis such as performing a mass scan across a predetermined mass range for an introduced sample to obtain the mass spectrum data. The data processor 2 which receives the mass spectrum data is normally realized by a personal computer and executes a predetermined program which has been installed in the computer to achieve the processing functions which will be described later.

Specifically speaking, the data processor 2 includes, as functional blocks, a mass spectrum creator 21, a metabolite identification processor 22, and a deduction condition setting section 23. The mass spectrum creator 21 creates a mass spectrum based on the received data. The metabolite identification processor 22 performs a computational process which will be described later based on the mass spectrum obtained by a mass analysis to deduce the composition of the metabolite to be targeted, find one or more candidates for the composition, and provide the candidates to the output unit 4. The deduction condition setting section 23 sets the calculation condition for identifying the metabolite based on the information provided from the input unit 3. The input unit 3 corresponds to the information provision section in the present invention, the metabolite identification processor 22 corresponds to the composition deduction section, and the deduction condition setting section 23 corresponds to the condition computation section.

Next, an example of the identification process of a metabolite which is characteristic of the mass analyzing system will be explained with reference to the flowchart of FIG. 2. At this point, as an example, consider the case where the metabolite B of a certain drug A is to be identified. In other words, the drug A is the original substance and the metabolite B is the product. Suppose that the composition formula of the drug A is known and is C₆H₁₂O₆ (mass: 180.0634 u). The metabolite B is produced by a chemical change of the drug A through a metabolism (or drug metabolism).

In this case, the mass spectrometer 1 analyzes two samples as targets: an analyte (which has been obtained by actually administering the drug A to a living organism to be metabolized) and a control (which has been obtained by using the same conditions for the analyte but without administering the drug A). First, each of these two samples is analyzed in the mass spectrometer 1 and the mass spectra are created in the mass spectrum creator 21 (Step S1). The metabolite identification processor 22 compares the two mass spectra and extracts a peak or peaks which exist only on the analyte's mass spectrum (Step S2). Since the peak is newly generated by a metabolism, it is possible to deduce that the substance corresponding to this peak is a metabolite. Therefore, the mass of each peak is first compared with a previously prepared metabolite database to identify a known metabolite (Step S3).

In the case where a metabolite which is not registered in the metabolite database is existent in the analyte, an unidentified peak or peaks remain. This is an unknown metabolite. Then, the unknown metabolite's peak is extracted and the mass is read (Step S4). In the case where all the metabolites have been identified in the process of Step S3, no action is taken. However, in the case where an unknown metabolite exists, for example, a notice of the existence is provided to the output unit 4. In response to this, the user provides information on the drug metabolism through the input unit 3 (Step S5). Generally, much information has been known for metabolic pathways from past studies. For example, a drug metabolism is composed of roughly two stages' reaction of the first phase and the second phase. In the first phase, a hydrolysis, oxidation, reduction or another type of reaction is likely to occur, and in the second phase, a sulfuric acid, acetic acid, glutathione, or other substance is added. Given this factor, the kind of such a reaction and the kind of substance (e.g. polar group) which is added or dropped is provided as information.

After the provision of the information (or prediction information) on the metabolism, the deduction condition setting section 23 computes, based on the information, each constituent element's maximum increase and maximum decrease associated with the metabolism (Step S6). The maximum increase and the maximum decrease define the variation range of the number of atoms of the constituent element which changes associated with the metabolism. At this point, suppose that the kind and number of atoms of the elements of drug A associated with the metabolism is obtained as in the following table.

TABLE 1

| | Decrease in | Increase in |
|---|---|---|
| Element | Number of Atoms | Number of Atoms |
| C | −3 | 6 |
| H | −6 | 12 |
| O | −2 | 2 |
| N | 0 | 2 |
| S | 0 | 2 |

For example, the number of atoms of carbon (C) can decrease by up to three and increase by up to six from the original drug A in a change.

In addition, since the composition of drug A is known, based on the known composition and each aforementioned constituent element's maximum increase and maximum decrease, a condition table is provided for obtaining the range of the possible kind and number of atoms of constituent elements of an unknown metabolite (Step S7). For example, corresponding to Table 1, the kind and the maximum value and minimum value of the number of atoms of the constituent elements of an unknown metabolite are obtained as shown in Table 2.

TABLE 2

| Element | Maximum Number | Minimum Number |
|---|---|---|
| C | 3 | 12 |
| H | 6 | 24 |
| O | 4 | 8 |
| N | 0 | 2 |
| S | 0 | 2 |

This is the precondition of the computation for deducing the composition of the unknown substance. The metabolite identification processor 22 uses this as a computational condition and searches for the combination of the elements to match the mass of the unknown metabolite given by the peak as previously described to deduce the composition (Step S8). For example, in the case where the unknown metabolite's mass is 194.0790 u, a predetermined tolerable range is set in which a measurement error or other factors are considered for the mass, and the combination of the elements within the tolerable range is searched. If the kind and number of atoms of the elements are not limited, the number of combinations to be compared becomes enormous and the number of combinations to match the metabolite's mass also becomes huge, which are impractical. On the other hand, with the apparatus of the present embodiment, since the kind and number of atoms of the elements are limited as previously described, the computation is relatively simple and the number of atoms of the elements selected as candidates is also small. Then, the candidates for the composition as gathered in this manner are listed and provided from the output unit 4 (Step S9).

In the aforementioned embodiment, the deduction of the composition is performed from the original mass of the unknown metabolite under the computation condition as illustrated in Table 2. However, if it is known that the change associated with the metabolism is a simple change that only adds something to the drug A or conversely drops something from the drug A, or if such a fact can be deduced or presumed, it is often advantageous to deduce the composition regarding the difference between the mass of drug A and the mass of metabolite B. This is because, unless a component having a good mass amount is added or dropped, the value of the mass change associated with the metabolism is fairly small compared to the value of the mass of metabolite B, and the number of possible combinations of the elements is also small.

In the aforementioned example, in the case where the mass of the unknown metabolite is 194.0790 u, the difference from drug A is: 194.0790-180.0634=14.0156 u. Setting the tolerable range of the mass difference to be ±10 mu and using the element's kind and number of atoms illustrated in Table 1 as a computational condition, the consistent combinations are searched. The result is shown in the following Table 3.

TABLE 3

| # | Mass | Diff. | Formula | DBE |
|---|---|---|---|---|
| 1 | 14.0157 | 0.00005 | CH₂ | 1.0 |

That is, only CH₂ is pertinent. Therefore, under the assumption that the unknown metabolite is a substance in which something is added to drug A, the composition of the unknown metabolite can be deduced to be C₇H₁₄O₆, in which CH₂ is added to the composition of drug A.

As previously described, with the mass analysis data analyzing method and the apparatus thereof according to the present invention, it is possible to easily and accurately deduce the composition of an unknown metabolite which has not been predicted.

It should be noted that the aforementioned embodiment is an example of the present invention, and therefore it is evident that any modification, adjustment or addition properly made within the spirit of the preset invention is also covered by the claims of the present patent application. For example, the present invention can be used for the identification of an unknown substance created in association with not only a change by metabolism, but a general chemical change such as a chemical change by a synthesis of a high molecular compound.

1. A mass analysis data analyzing method for deducing a composition of a product generated by a chemical change of an original substance whose composition is known, based on data obtained by mass analyzing the product, comprising:
a) an information provision step for providing prediction information on the chemical change;
b) a condition computation step for computing, based on the prediction information, a maximum increase and a maximum decrease in the number of atoms of each element from the original substance by the chemical change and/or a maximum value and a minimum value of the number of atoms of each element constituting the product; and
c) a composition deduction step for deducing the composition of the product to match a mass of the product obtained by a mass analysis, under a computational condition of the maximum increase and the maximum decrease in the number of atoms of each element or the maximum value and the minimum value of the number of atoms of a constituent element of the product computed in the condition computation step.

2. The mass analysis data analyzing method according to claim 1, wherein:
in the composition deduction step, a composition corresponding to a difference between a mass of the original substance and the mass of the product is deduced under a condition of the maximum increase and the maximum decrease in the number of atoms of each element obtained in the condition computation step, and based on the deduced composition and the composition of the original substance, the composition of the product is deduced.

3. A mass analysis data analyzing apparatus for deducing a composition of a product generated by a chemical change of an original substance whose composition is known, based on data obtained by mass analyzing the product, comprising:
a) an information provision section for providing prediction information on the chemical change;
b) a condition computation section for computing, based on the prediction information, a maximum increase and a maximum decrease in the number of atoms of each element from the original substance by the chemical change and/or a maximum value and a minimum value of the number of atoms of each element constituting the product; and
c) a composition deduction section for deducing the composition of the product to match a mass of the product obtained by a mass analysis, under a computational condition of the maximum increase and the maximum decrease in the number of atoms of each element or the maximum value and the minimum value of the number of atoms of a constituent element of the product computed by the condition computation section.

4. The mass analysis data analyzing apparatus according to claim 3, wherein:
in the composition deduction section, a composition corresponding to a difference between a mass of the original substance and the mass of the product is deduced under a condition of the maximum increase and the maximum decrease in the number of atoms of each element obtained by the condition computation section, and based on the deduced composition and the composition of the original substance, the composition of the product is deduced.

5. The mass analysis data analyzing method according to claim 1, wherein a predetermined tolerance is set in the composition deduction step.

6. The mass analysis data analyzing method according to claim 2, wherein a predetermined tolerance is set in the composition deduction step.

7. The mass analysis data analyzing apparatus according to claim 3, wherein a predetermined tolerance is set in deducing the composition of the product by the composition deduction section.

8. The mass analysis data analyzing apparatus according to claim 4, wherein a predetermined tolerance is set in deducing the composition of the product by the composition deduction section.
